(19) United States
(12) Patent Application Publication
(10) Pub. No.: US 2012/0036228 A1
(43) Pub. Date: Feb. 9, 2012

(54) IMAGE SHARING SYSTEM

(75) Inventors: Shuhei Ichinose, Kanagawa (JP); Tomoki Ohkawa, Kanagawa (JP)

(73) Assignees: Pioneer Solutions Corporation, Kawasaki-shi (JP); Pioneer Corporation, Kawasaki-shi (JP)

(21) Appl. No.: 13/264,208

(22) PCT Filed: Apr. 15, 2009
(86) PCT No.: PCT/JP2009/057579

§ 371 Date: Oct. 13, 2011

(51) Int. Cl. G06F 15/16

(52) U.S. Cl. 709/219

(57) ABSTRACT

A personal terminal of an image sharing system transmits distribution request information to a server each time a start of an image sharing process is recognized and downloads shared terminal information of a shared terminal as a destination and personal-terminal image sharing software from the server. Then, the personal terminal runs the personal-terminal image sharing software without installation thereof and transmits/receives an image to/from the shared terminal as a destination corresponding to the shared terminal information not through the server to perform the image sharing process.

### TECHNICAL FIELD

The present invention relates to an image sharing system, a server, an image sharing method, an image sharing controlling method, and a recording medium recorded with the image sharing controlling method.

### BACKGROUND ART

Conventionally, there has been known an arrangement in which an image is shared among a plurality of terminals (see Patent Literature 1).

In Patent Literature 1, a terminal at a user's side (hereinafter, referred to as a user terminal) and a terminal at a support center (hereinafter, referred to as a support terminal) log in to a server and are connected to each other via the server. The server generates display data based on image data uploaded by the support terminal. This display data is transmitted to the user terminal for display, whereby the display data is shared between the support terminal and the user terminal.

### CITATION LIST

### Patent Literature

Patent Literature 1 JP-A-2003-108504

### SUMMARY OF THE INVENTION

### Problems to be Solved by the Invention

In such an arrangement as that in Patent Literature 1, an image is transmitted and received via the server. Accordingly, the larger the number of image sharing terminals is, the more load may be applied on the server. A server at higher performance may be used for dealing with such load. However, such a high-performance server is expensive.

Moreover, when the image is shared via a network, it cannot be judged whether it is caused by the network, a network connection configuration at a personal terminal, image sharing software or a configuration of the image sharing software. Accordingly, an appropriate countermeasure may not be promptly taken.

An object of the invention is to provide an image sharing system capable of taking an appropriate countermeasure even in connection failure without increasing costs, a server, an image sharing method, an image sharing controlling method, and a recording medium recorded with the image sharing controlling method.

### Means for Solving the Problems

An image sharing system according to an aspect of the invention includes: a first terminal provided with a first terminal display capable of displaying a predetermined image; a second terminal provided with a second terminal display capable of displaying a predetermined image, the second terminal being connectable to the first terminal via a network; and a server connectable to the first and second terminals via the network, the image sharing system performing an image sharing process in which the image displayed on the second terminal is simultaneously displayed on the first terminal, in which the server includes: a server storage in which first terminal information for identifying the first terminal and a second image sharing software for performing the image sharing process at the second terminal are stored; and a server distributor that distributes the first terminal information and the second image sharing software to the second terminal in response to distribution request information transmitted from the second terminal, the first terminal includes a first image sharing processor that acquires a first image sharing software for performing the image sharing process and performs the image sharing process with the second terminal according to the first image sharing software, and the second terminal includes: a distribution request information transmitter that transmits the distribution request information to the server each time a start of the image sharing process is recognized; a data acquirer that acquires the first terminal information and the second image sharing software in response to the distribution request information; and a second image sharing processor that runs the second image sharing software after the data acquirer acquires the second image sharing software and that performs the image sharing process with the first terminal identified by the first terminal information, not through the server.

An image sharing system according to another aspect of the invention includes: a first terminal provided with a first terminal display capable of displaying a predetermined image; and a second terminal provided with a second terminal display capable of displaying a predetermined image, the second terminal being connectable to the first terminal via a network, the image sharing system performing an image sharing process in which the image displayed on the second terminal is simultaneously displayed on the first terminal, in which the first terminal includes: a first terminal storage in which a second image sharing software for performing the image sharing process at the second terminal is stored; a first terminal distributor that distributes the second image sharing software to the second terminal in response to distribution request information transmitted from the second terminal; and a first image sharing processor that acquires a first image sharing software for performing the image sharing process and performs the image sharing process with the second terminal according to the first image sharing software, and the second terminal includes: a distribution request information transmitter that transmits the distribution request information to the first terminal each time a start of the image sharing process is recognized; a data acquirer that acquires the second image sharing software in response to the distribution request information; and a second image sharing processor that runs the second image sharing software after the data acquirer acquires the second image sharing software to perform the image sharing process with the first terminal.

According to still another aspect of the invention, a server that controls an image sharing process, the server being connectable via a network with: at least one first terminal provided with a first terminal display capable of displaying a predetermined image; and a second terminal provided with a second terminal display capable of displaying a predetermined image, the second terminal being connectable to the first terminal via the network, the image sharing process allowing an image displayed on the second terminal to be simultaneously displayed on the first terminal, the server includes: a server storage in which a first terminal information for identifying the first terminal and a second image sharing software for performing the image sharing process at the second terminal are stored; an image-sharable terminal recognition unit that recognizes the first terminal among a plurality of the first terminals, the first terminal having a first image sharing software running and being capable of performing the image sharing process with the second terminal, the first terminal information of the plurality of the first terminals being stored in the server storage; and a server distributor that distributes the first terminal information of the first terminal being recognized by the image-sharable terminal recognition unit to be capable of performing the image sharing process and the second image sharing software to the second terminal in response to the distribution request information, and that runs the second image sharing software on the second terminal in response to the distribution to perform the image sharing process between the second terminal and the first terminal identified by the first terminal information not through the server.

According to a further aspect of the invention, an image sharing method of performing an image sharing process using: a first terminal provided with a first terminal display capable of displaying a predetermined image; a second terminal provided with a second terminal display capable of displaying a predetermined image, the second terminal being connectable to the first terminal via a network; and a server connectable to the first and second terminals via the network, the image sharing process allowing the image displayed on the second terminal to be simultaneously displayed on the first terminal, the server including a server storage that stores first terminal information for identifying the first terminal and a second image sharing software for performing the image sharing process at the second terminal, the method including: transmitting distribution request information from the second terminal to the server each time a start of the image sharing process is recognized at the second terminal; distributing the first terminal information and the second image sharing software from the server to the second terminal in response to the distribution request information; and when the second image sharing software is acquired on the second terminal, running the second image sharing software on the second terminal to perform the image sharing process between the second terminal and the first terminal that is identified by the first terminal information and is capable of performing the image sharing process according to a first image sharing software, not through the server.

According to a still further aspect of the invention, an image sharing method of performing an image sharing process using: a first terminal provided with a first terminal display capable of displaying a predetermined image; and a second terminal provided with a second terminal display capable of displaying a predetermined image, the second terminal being connectable to the first terminal via a network, the image sharing process allowing the image displayed on the second terminal to be simultaneously displayed on the first terminal, the first terminal including a first terminal storage in which a second image sharing software for performing the image sharing process at the second terminal is stored; the method including: transmitting distribution request information from the second terminal to the first terminal each time a start of the image sharing process is recognized at the second terminal; distributing the second image sharing software from the first terminal to the second terminal in response to the distribution request information; and when the second image sharing software is acquired on the second terminal, running the second image sharing software on the second terminal to perform the image sharing process between the second terminal and the first terminal that is capable of performing the image sharing process according to a first image sharing software, not through the server.

An image-sharing controlling program according to a still further aspect of the invention is a program that causes a computer to function as the aforementioned server.

A recording medium according to a still further aspect of the invention is a recording medium on which the aforementioned image sharing controlling program is recorded in a computer-readable manner.

### BRIEF DESCRIPTION OF DRAWINGS

FIG. 1 is a block diagram schematically showing an arrangement of an image sharing system according to first and second exemplary embodiments of the invention.

FIG. 2 is a block diagram schematically showing an arrangement of first, second and third shared terminals according to the first exemplary embodiment.

FIG. 3 is a block diagram schematically showing an arrangement of a server according to the first and second exemplary embodiments.

FIG. 4 is a block diagram schematically showing an arrangement of a personal terminal according to the first exemplary embodiment.

FIG. 5 is a flow chart showing an overall operation of the server according to the first exemplary embodiment.

FIG. 6 is a flow chart showing distribution process to the shared terminals in the server according to the first exemplary embodiment.

FIG. 7 is a flow chart showing image-sharable terminal recognition process in the server according to the first exemplary embodiment.

FIG. 8 is a flow chart showing selection request process to the personal terminal in the server according to the first exemplary embodiment.

FIG. 9 is a flow chart showing distribution process to the personal terminal in the server according to the first exemplary embodiment.

FIG. 10 is a flow chart showing an operation of the first shared terminal according to the first exemplary embodiment.

FIG. 11 is a flow chart showing an operation of the personal terminal according to the first exemplary embodiment.

FIG. 12 is a flow chart showing an operation of the personal terminal according to the first and second exemplary embodiments and a modification of the invention.

FIG. 13 is a block diagram schematically showing an arrangement of first, second and third shared terminals according to a second exemplary embodiment.

FIG. 14 is a block diagram schematically showing an arrangement of a personal terminal according to the second exemplary embodiment.

FIG. 15 is a flow chart showing an operation of the first shared terminal according to the second exemplary embodiment.

FIG. 16 is a flow chart showing an operation of the personal terminal according to the second exemplary embodiment.

FIG. 17 is a block diagram schematically showing an arrangement of an image sharing system according to a third exemplary embodiment of the invention.

FIG. 18 is a block diagram schematically showing an arrangement of first shared terminal according to the third exemplary embodiment.

FIG. 19 is a block diagram schematically showing an arrangement of a server according to the modification.

FIG. 20 is a flow chart showing an operation of a personal terminal according to the modification.

### DESCRIPTION OF EXEMPLARY EMBODIMENTS

### First Exemplary Embodiment

A first exemplary embodiment of the invention will be described below with reference to the attached drawings.

This first exemplary embodiment and later described second and third exemplary embodiments illustrate an image sharing system that performs an image sharing process in which an image being displayed on a first terminal is simultaneously displayed on a second terminal. Moreover, the first and third exemplary embodiments illustrate an arrangement of the image sharing system in which software for the image sharing process is run without being installed. The second exemplary embodiment illustrates an arrangement of the image sharing system in which software for the image sharing process is run after being installed. The third exemplary embodiment is a modification of the first exemplary embodiment. The third exemplary embodiment illustrates an arrangement of the image sharing system in which a decimal IP address of the second terminal is converted to a hexadecimal IP address for a display on the first terminal. An idea represented by “simultaneously” in the image sharing process includes slightly different timing as well as strictly the same timing.

Arrangement of Image Sharing System

Firstly, an arrangement of the image sharing system will be described.

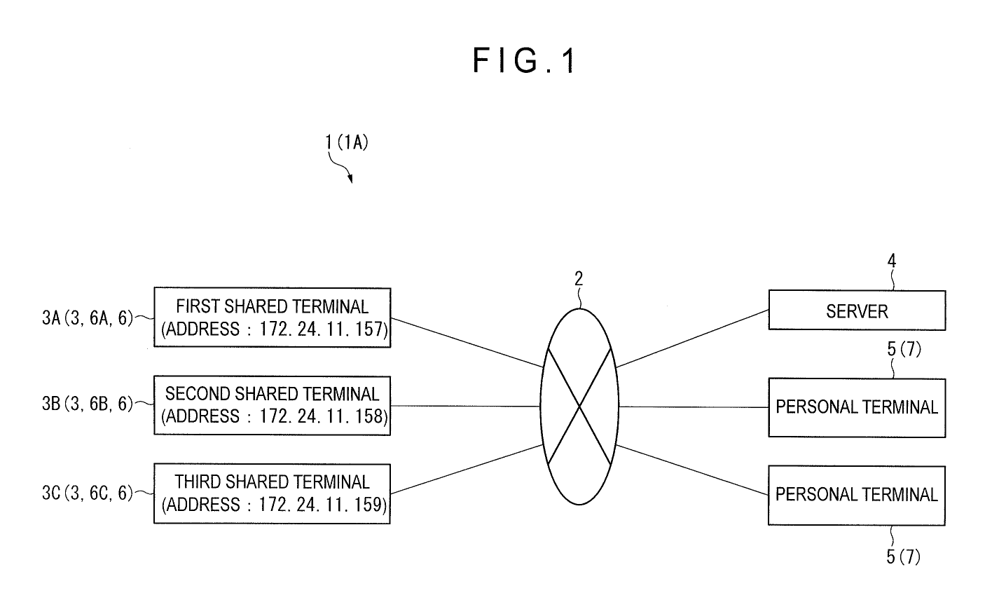

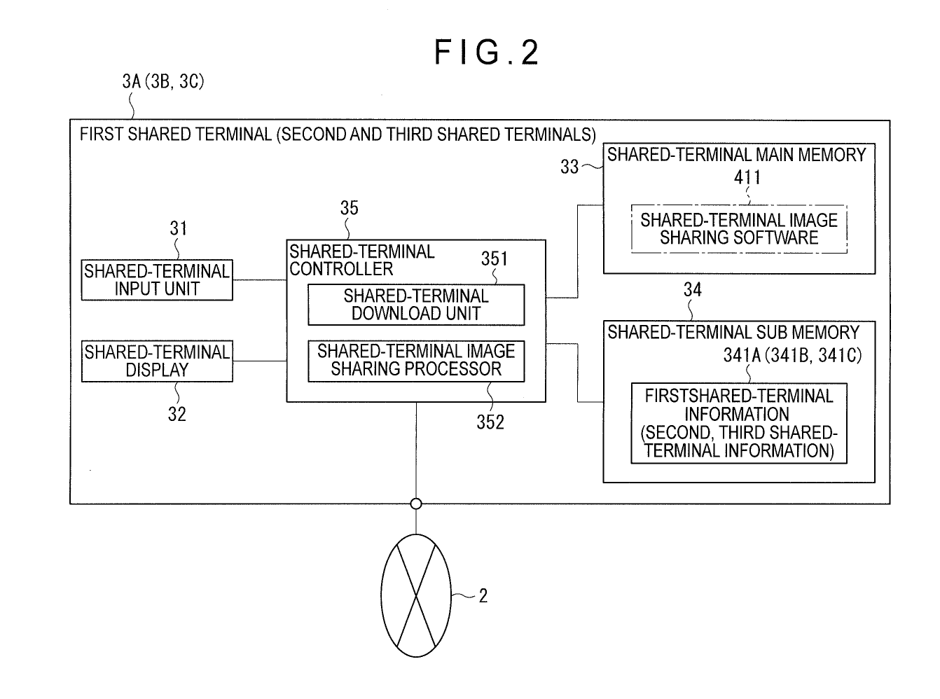

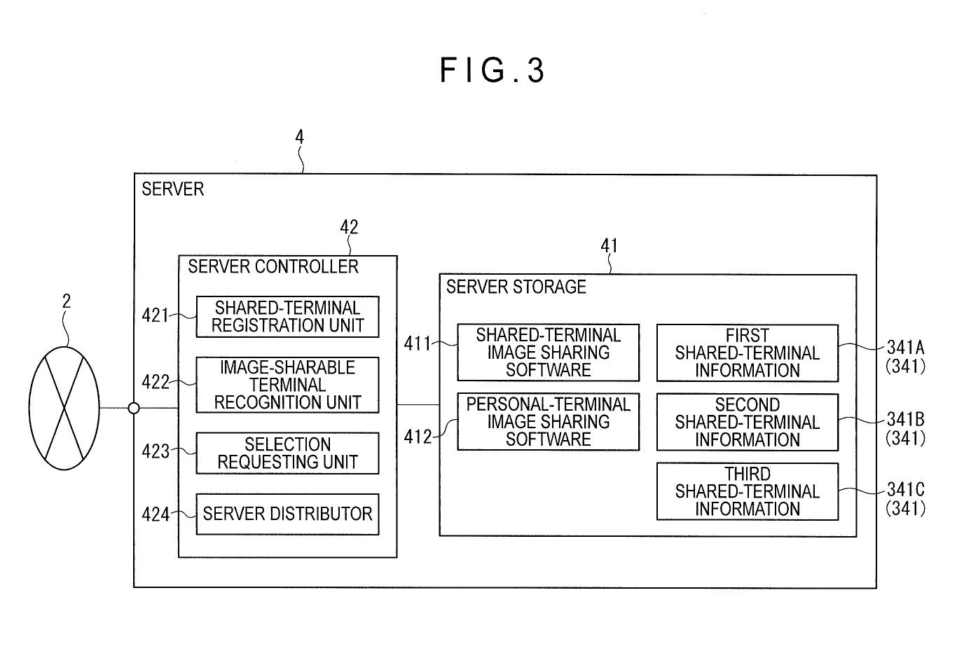

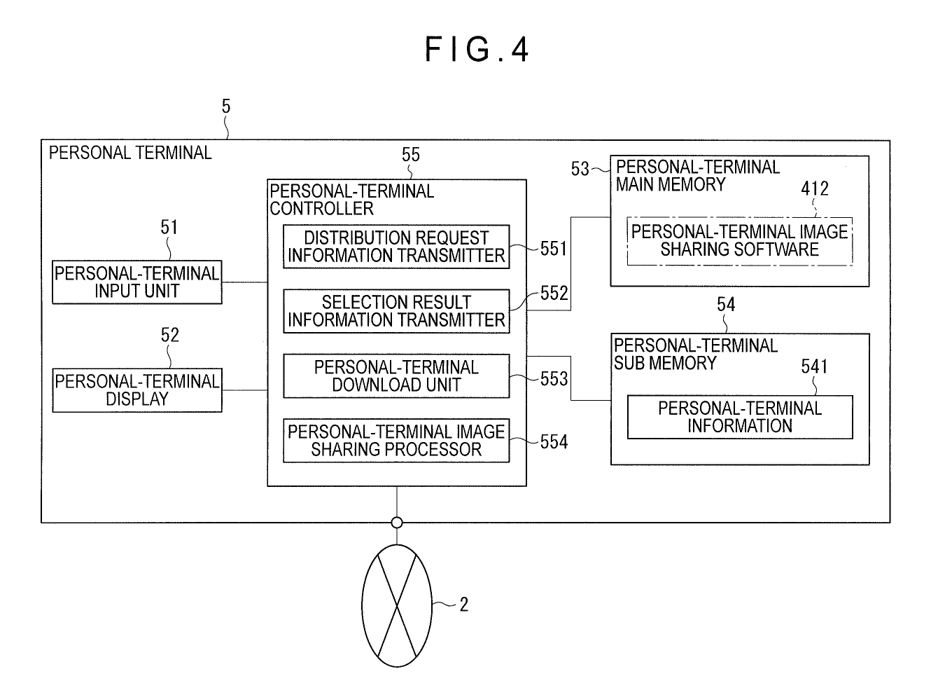

FIG. 1 is a block diagram schematically showing an arrangement of the image sharing system according to the first and second exemplary embodiments. FIG. 2 is a block diagram schematically showing an arrangement of first, second and third shared terminals. FIG. 3 is a block diagram schematically showing an arrangement of a server. FIG. 4 is a block diagram schematically showing an arrangement of a personal terminal.

As shown in FIG. 1, an image sharing system 1 includes: a network 2; first, second and third shared terminals 3A, 3B and 3C (the first terminal); a server 4; and two personal terminals 5 (the second terminal). Hereinafter, an unspecified one of the first, second and third shared terminals 3A, 3B and 3C is represented by a shared terminal 3 for description. The number of each of the shared terminal 3 and the personal terminal 5 is not limited to the number described above.

The first, second and third shared terminals 3A, 3B and 3C, the server 4 and the personal terminal 5 are connected to each other by the network 2 in such a manner that various information is transmittable and receivable.

The first, second and third shared terminals 3A, 3B and 3C each are a desk-top computer or a lap-top computer that is provided, for instance, in a meeting room and is usable by an unspecified user. As shown in FIG. 2, the first, second and third shared terminals 3A, 3B and 3C each include: a shared-terminal input unit 31 with a manipulation button (not shown); a shared-terminal display 32 (a first terminal display) capable of displaying an image (not shown) shared with the personal terminal 5; a shared-terminal main memory 33 (e.g., a memory); a shared-terminal sub memory 34 (e.g., a hard disc); and a shared-terminal controller 35. The shared-terminal display 32 may be integrally formed with the shared-terminal input unit 31, the shared-terminal main memory 33, the shared-terminal sub memory 34 and the shared-terminal controller 35. Alternatively, the shared-terminal display 32 may be separately provided. The shared-terminal display 32 may be a liquid crystal panel, a PDP (Plasma Display Panel) or a liquid crystal projector.

A shared-terminal image sharing software 411 (a first image sharing software) that is downloaded from the server 4 is run on the shared-terminal main memory 33.

First shared-terminal information 341A (first terminal information) about the first shared terminal 3A is stored in the first shared-terminal sub memory 34 of the first shared terminal 3A. Second shared-terminal information 341B (first terminal information) about the second shared terminal 3B is stored in the shared-terminal sub memory 34 of the second shared terminal 3B. Third shared-terminal information 341C (first terminal information) about the third shared terminal 3C is stored in the shared-terminal sub memory 34 of the third shared terminal 3C. The first to third shared-terminal information 341A to 341C at least includes information capable of identifying the first to second shared terminals. The first to third shared-terminal information 341A to 341C may further include quality information for controlling quality of the shared image. The information capable of identifying the first, second and third shared terminals 3A, 3B and 3C is a decimal IP address of each of the first, second and third shared terminals 3A, 3B and 3C: “172.24.11.157” (see FIG. 1), “172.24.11.158” (see FIG. 1), and “172.24.11.159” (see FIG. 1).

Combination of the IP address with a port number and a serial number may be used as the information that is included in the first terminal information of the invention and is capable of identifying the terminal. Any one of the first to third shared-terminal information 341A to 341C is represented by shared-terminal information 341 for description.

The shared-terminal controller 35 includes a shared-terminal download unit 351 and a shared-terminal image sharing processor 352 (a first image sharing processor), both of which are provided by various programs.

The shared-terminal download unit 351 downloads the shared-terminal image sharing software 411 from the server 4 according to input by the user.

The shared-terminal image sharing processor 352 performs the image sharing process when the shared-terminal image sharing software 411 stored in the shared-terminal main memory 33 is run on the shared-terminal main memory 33 without being installed according to the user's input for running the shared-terminal image sharing software 411. Subsequently, for instance, the shared-terminal image sharing processor 352 of the first shared terminal 3A transmits the first shared-terminal information 341A to the server 4 according to the user's input to the shared-terminal input unit 31, whereby the shared-terminal image sharing processor 352 registers the first shared terminal 3A as a device capable of performing the image sharing process with the personal terminal 5. When recognizing an image sharing connection request from the personal terminal 5, the shared-terminal image sharing processor 352 performs the image sharing process.

When the user inputs to terminate the shared-terminal image sharing software 411, the shared-terminal image sharing processor 352 deletes the shared-terminal image sharing software 411 from the shared-terminal main memory 33. Thus, the shared-terminal image sharing processor 352 runs the shared-terminal image sharing software 411 without installation thereof. Accordingly, when the image sharing process is repeated after termination of the shared-terminal image sharing software 411, the shared-terminal image sharing software 411 is newly downloaded from the server 4. The shared-terminal image sharing processor 352 may automatically perform the above process after the shared-terminal image sharing software 411 is downloaded irrespective of the presence of the input by the user. An operation of the shared-terminal controller 35 will be described in detail below.

“To run the shared-terminal image sharing software 411 without installation thereof” will be described in detail.

“To install (or installation)” means to copy a program or data composing an application software (hereinafter, referred to as an application) to the shared-terminal sub memory 34 such as a hard disc for necessary configuration. In short, “to install” means to store the application in the shared-terminal sub memory 34. With this arrangement, the next activation of the application can be performed by reading out the program or data from the shared-terminal sub memory 34.

In contrast, “to run without installation thereof” according to this exemplary embodiment means to run the downloaded program or data on the shared-terminal main memory 33 to execute the application. Since the application is only run on the shared-terminal main memory 33, the application will be deleted when the application is not necessary to be present on the shared-terminal main memory 33, for instance, when the application is terminated. Accordingly, for activating the application next time, as described above, the shared-terminal image sharing processor 352 newly downloads the shared-terminal image sharing software 411 from the server 4.

In a general arrangement in which an application is downloaded via a browser on the web, a region (i.e., a temporary folder) is created in the shared-terminal sub memory 34 and the application is temporarily kept in the region. In such a case, the contents of the temporary folder, which are temporarily kept, are not stored in the shared-terminal sub memory 34. Accordingly, such a case is included in the idea of “to run without installation thereof” according to this exemplary embodiment.

As shown in FIG. 3, the server 4 (a computer) includes a server storage 41 (a hard disc) and a server controller 42.

The shared-terminal image sharing software 411 for causing the shared terminal 3 to perform the image sharing process, personal-terminal image sharing software 412 (a second image sharing software) for causing the personal terminal 5 to perform image sharing process, and the first to third shared-terminal information 341A to 341C are stored in the server storage 41. When all of the first to third shared-terminal information 341A to 341C are registered as an image-sharable device, all of the first to third shared-terminal information 341A to 341C can be stored. For instance, when only the first shared terminal 3A is registered, only the first shared-terminal information 341A is stored.

The server controller 42 includes a shared-terminal registration unit 421, an image-sharable terminal recognition unit 422, a selection requesting unit 423, and a server distributor 424, all of which are provided by an image sharing controlling program of the invention.

The shared-terminal registration unit 421 receives the first to third shared-terminal information 341A to 341C transmitted from the first to third shared terminals 3A to 3C and stores the first to third shared-terminal information 341A to 341C in the server storage 41.

The image-sharable terminal recognition unit 422 recognizes such a shared terminal 3 that is capable of performing the image sharing process while the shared-terminal image sharing software 411 is running.

When receiving distribution request information from the personal terminal 5, the selection requesting unit 423 transmits a destination selection request image (not shown) as selection request information to the personal terminal 5. The selection request information requests the personal terminal 5 to select at least one of the shared terminals 3 recognized by the image-sharable terminal recognition unit 422 as being capable of performing the image sharing process. The selection requesting unit 423 may transmit the destination selection request image when the selection requesting unit 423 recognizes the request from the personal terminal 5 or when the selection requesting unit 423 recognizes establishment of connection with the personal terminal 5.

The server distributor 424 distributes the shared-terminal image sharing software 411 to the first to third shared terminals 3A to 3C. Also, when the server distributor 424 receives selection result information from the personal terminal 5 indicating that the shared terminal 3 as a destination has been selected from the shared terminals 3 recognized as being capable of performing the image sharing process, the server distributor 424 distributes to the personal terminal 5 the personal-terminal image sharing software 412 and the shared-terminal information 341 of the shared terminal 3 as a destination.

An operation of the server controller 42 will be described in detail below.

The personal terminal 5 is a desk-top computer provided on a desk of a specific user or a lap-top computer owned by the user. As shown in FIG. 4, the personal terminal 5 includes: a personal-terminal input unit 51 with a manipulation button (not shown); a personal-terminal display 52 (a second terminal display and notifier) capable of displaying an image (not shown) shared with the first to third shared terminals 3A to 3C; a personal-terminal main memory 53 (e.g., a memory) in which the personal-terminal image sharing software 412 is temporarily stored; a personal-terminal sub memory 54 (e.g., a hard disc) in which the personal-terminal information 541 is stored; and a personal-terminal controller 55.

The personal-terminal controller 55 includes a distribution request information transmitter 551, a selection result information transmitter 552, a personal-terminal download unit 553 (a data acquirer), and a personal-terminal image sharing processor 554 (a second image sharing processor), all of which are provided by various programs.

When recognizing that the image sharing process is started according to the input by the user to the personal-terminal input unit 51, the distribution request information transmitter 551 activates a web browser to display a browser screen (not shown) on the personal-terminal display 52. The distribution request information transmitter 551 judges whether or not the connection with the server 4 is established. When determining that the connection with the server 4 is not established, the distribution request information transmitter 551 displays on the personal-terminal display 52 that failure of the network 2 causes non-connection. On the other hand, when determining that the connection with the server 4 is established, the distribution request information transmitter 551 transmits distribution request information to the effect to the server 4.

When the connection with the server 4 is established, the selection result information transmitter 552 receives the destination selection request image from the server 4 and displays the destination selection request image on the browser screen. When the shared terminal 3 as a destination is selected according to the input by the user from the shared terminals 3 being capable of performing the image sharing process, the selection result information transmitter 552 transmits the selection result information to the effect to the server 4.

The personal-terminal download unit 553 downloads the personal-terminal image sharing software 412 and the shared-terminal information 341 of the shared terminal 3 as a destination from the server 4 according to the input by the user.

The personal-terminal image sharing processor 554 performs image sharing process when the personal-terminal image sharing software 412 is downloaded and is run on the personal-terminal main memory 53 without being installed according to the input by the user. Specifically, the personal-terminal image sharing processor 554 establishes the connection with the shared terminal 3 as a destination which is identified by the IP address of the shared-terminal information 341, and transmits the image to be displayed on the personal-terminal display 52 not through the server 4.

After the image sharing process, the personal-terminal image sharing processor 554 deletes the personal-terminal image sharing software 412 from the personal-terminal main memory 53. Thus, the personal-terminal image sharing processor 554 runs the personal-terminal image sharing software 412 without installation thereof. Accordingly, when the image sharing process is repeated after deletion of the personal-terminal image sharing software 412, the personal-terminal image sharing software 412 is newly downloaded from the server 4. The personal-terminal image sharing processor 554 may automatically perform the above process after the personal-terminal image sharing software 412 is downloaded irrespective of the presence of the input by the user.

“To run the personal-terminal image sharing software 412 without installation thereof” is similar to what is meant by “to run the shared-terminal image sharing software 411 without installation thereof.” An operation of the personal-terminal controller 55 will be described in detail below.

Operation of Image Sharing System

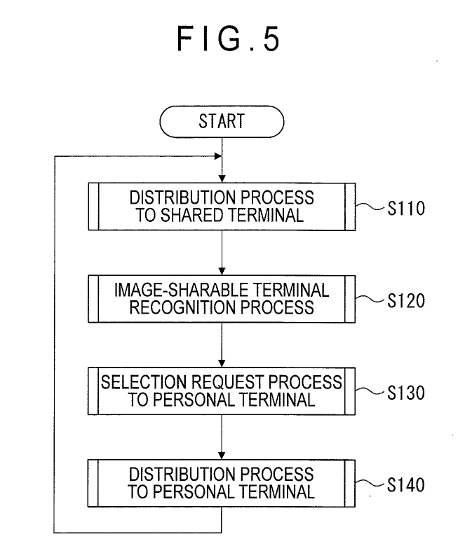

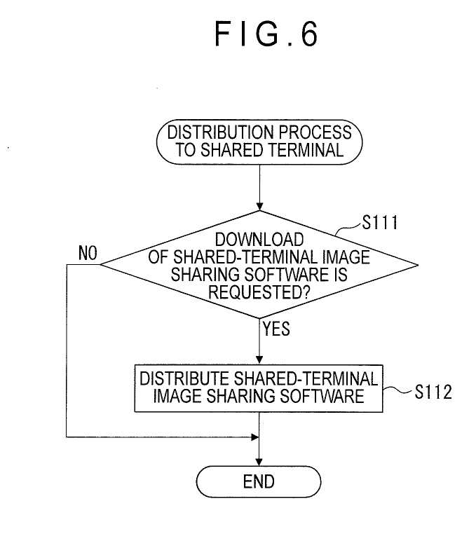

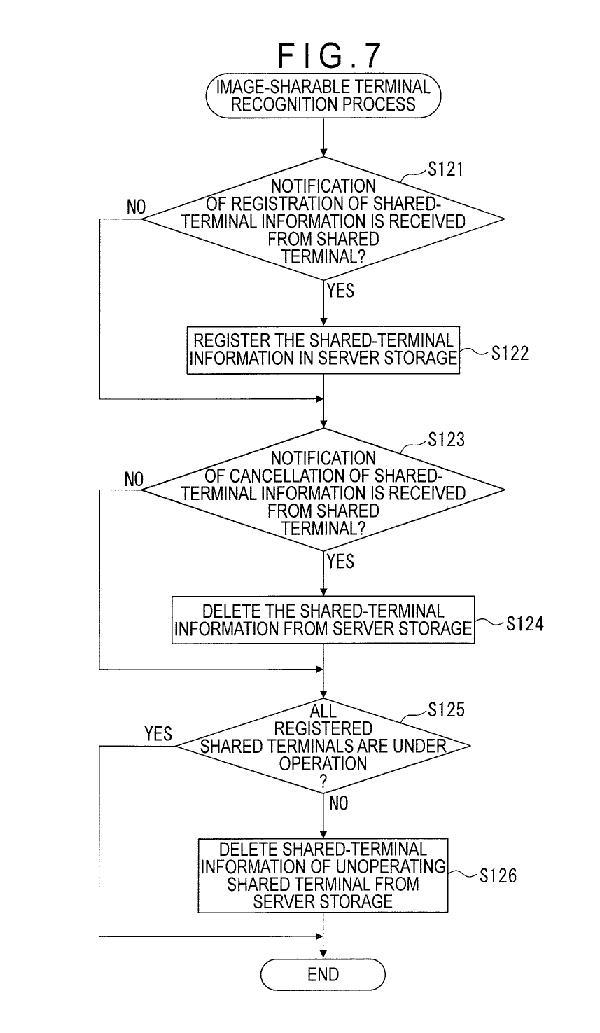

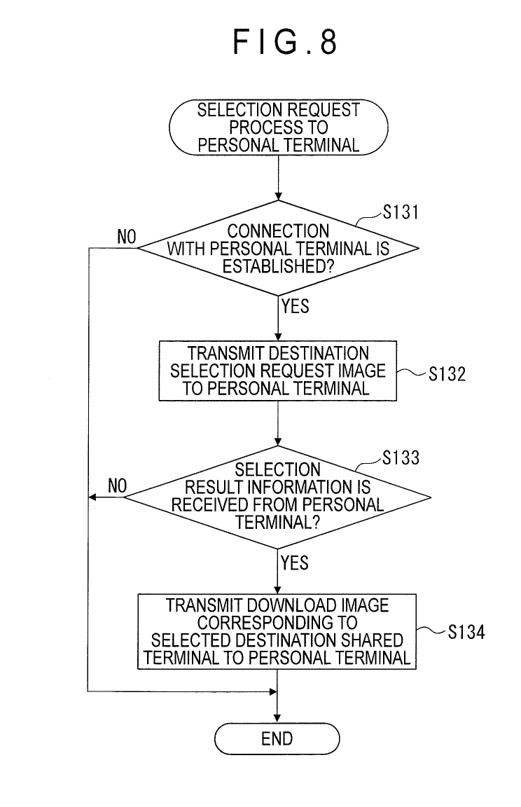

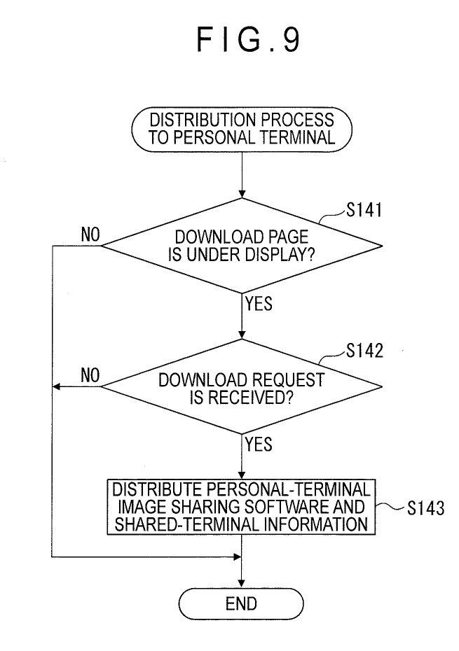

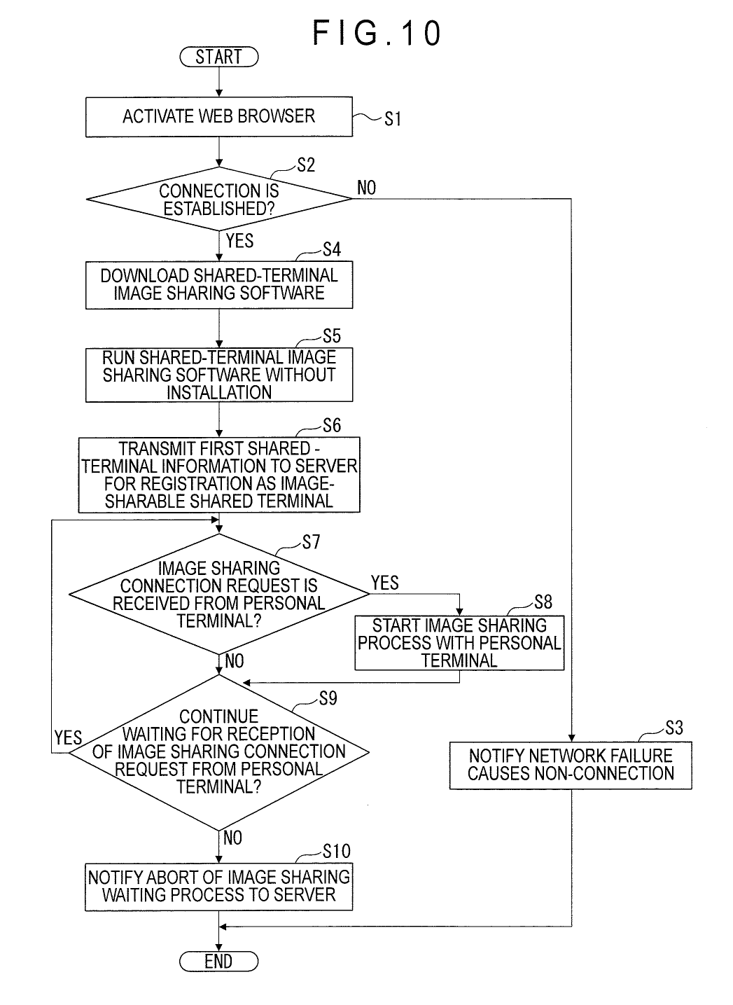

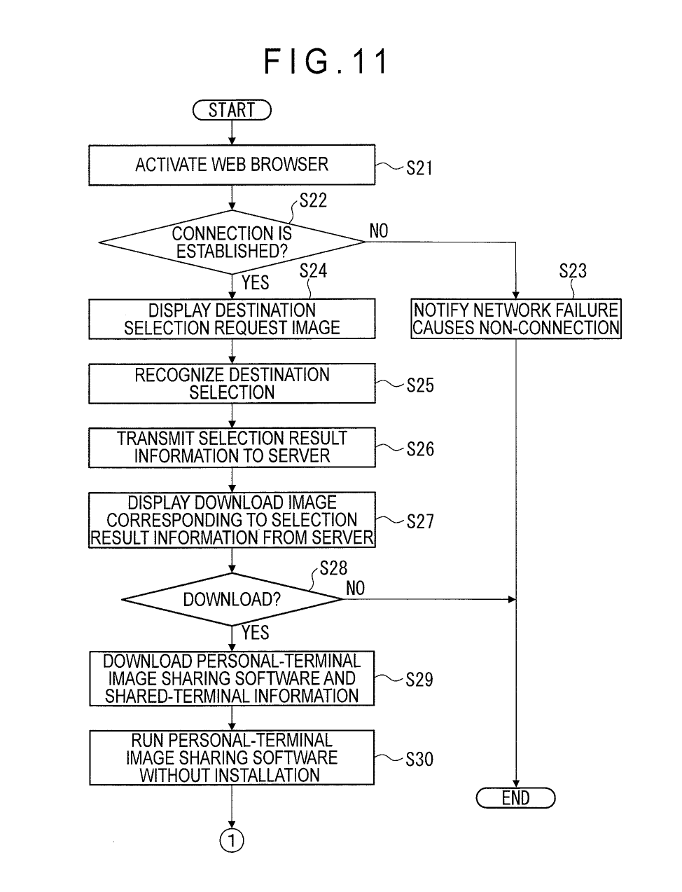

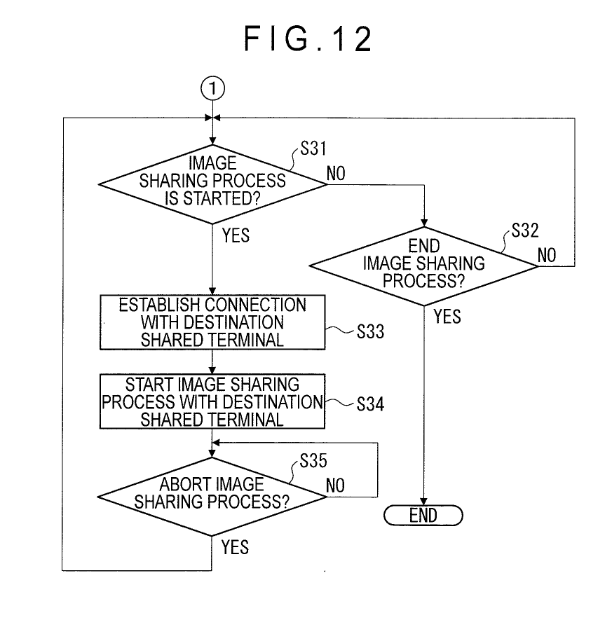

Next, an operation of the image sharing system 1 will be described. FIG. 5 is a flow chart showing an operation of the server. FIG. 6 is a flow chart showing distribution process to the shared terminal in the server. FIG. 7 is a flow chart showing image-sharable terminal recognition process in the server. FIG. 8 is a flow chart showing selection request process to the personal terminal in the server. FIG. 9 is a flow chart showing distribution process to the personal terminal in the server. FIG. 10 is a flow chart showing an operation of the first shared terminal. FIGS. 11 and 12 are a flow chart showing an operation of the personal terminal.

Operation of Server

As shown in FIG. 5, the server 4 of the image sharing system 1 performs the distribution process to the shared terminal (Step S110), the image-sharable terminal recognition process (Step S120), the selection request process to the personal terminal (Step S130), and the distribution process to the personal terminal (Step S140). Each process will be described in detail below.

In the distribution process to the shared terminal of Step 110, as shown in FIG. 6, the server distributor 424 of the server 4 judges whether or not at least one of the first to third shared terminals 3A to 3C requests download of the shared-terminal image sharing software 411 (Step S111). When determining in Step S111 that the request is made, the server distributor 424 distributes the shared-terminal image sharing software 411 to the shared terminal 3 of requesting source (Step S112) and terminates distribution process to the shared terminal. On the other hand, when determining in Step S111 that the request is not made, the server distributor 424 terminates distribution process to the shared terminal without performing the process of Step S112.

In recognition process of the terminal capable of sharing an image of Step 120, as shown in FIG. 7, the shared-terminal registration unit 421 of the server 4 judges whether to have received a notification of registering the shared-terminal information 341 from the shared terminal 3 in order to register this shared terminal 3 as one capable of sharing an image (Step S121). When determining reception of the notification in Step S121, the shared-terminal registration unit 421 registers (stores) the shared-terminal information 341 in the server storage 41 (Step S122). After the process of Step S122 or when determining in Step S121 that the notification of registration is not received, the shared-terminal registration unit 421 judges whether a notification of cancelling the registration of the shared-terminal information 341 has bee received from the shared terminal 3 in order to cancel the registration as the shared terminal 3 capable of sharing an image (Step S123). This notification of cancelling the registration is issued, for instance, when power of the shared terminal 3 is turned OFF by the shared-terminal image sharing software 411 or when the user inputs to terminate the image sharing process.

When determining in Step S123 that the notification of cancelling the registration is received, the shared-terminal registration unit 421 deletes the shared-terminal information 341 from the server storage 41 (Step S124). After the process of Step S124 or when determining in Step S123 that the notification of cancelling the registration is not received, the image-sharable terminal recognition unit 422 judges whether or not all the registered shared terminals 3 are under operation (Step S125). This judging process in Step S125 is performed based on, for instance, whether or not a communication session with the registered shared terminal 3 is maintained, or a result obtained by checking an operation in response to an operation check request.

When determining in Step S125 that the registered shared terminal 3 is not operated, the shared-terminal registration unit 421 deletes the shared-terminal information 341 of this registered shared terminal 3 from the server storage 41 and terminates the image-sharable terminal recognition process. On the other hand, when determining in Step S125 that all of the registered shared terminals 3 are under operation, the shared-terminal registration unit 421 terminates the image-sharable terminal recognition process without performing the process of Step S126.

In selection request process to the personal terminal (Step S130), as shown in FIG. 8, the selection requesting unit 423 of the server 4 judges whether the connection with the personal terminal 5 is established via the web browser (Step S131). When determining that the connection is not established, the selection requesting unit 423 terminates the selection request process to the personal terminal. On the other hand, when determining that the connection is established, the selection requesting unit 423 generates the destination selection request image based on the shared-terminal information 341 registered in the server storage 41 and transmits the destination selection request image to the personal terminal 5 (Step S132).

Subsequently, the selection requesting unit 423 judges whether the selection result information has been received from the personal terminal 5 (Step S133). When determining that the selection result information is not received, the selection requesting unit 423 terminates the selection request process to the personal terminal. When determining in Step S133 that the selection result information is received, the selection requesting unit 423 transmits to the personal terminal 5 the download image of the corresponding shared terminal 3 as a destination according to the selection result information and terminates selection request process to the personal terminal.

In distribution process to the personal terminal of Step S140, as shown in FIG. 9, the server distributor 424 of the server 4 judges whether or not the download image is under display on the personal terminal 5 (Step S141). When determining that the download image is not under display, the server distributor 424 terminates the distribution process to the personal terminal. On the other hand, when determining in Step S141 that the download image is under display, the server distributor 424 judges whether the download request has been received from the personal terminal 5 (Step S142). When determining that the download request is not received, the server distributor 424 terminates the distribution process to the personal terminal.

When determining in Step S142 that the download request is received, the server distributor 424 distributes the personal-terminal image sharing software 412 and the shared-terminal information 341 to the personal terminal 5 (Step S143) and terminates the distribution process to the personal terminal.

### Operation of Shared Terminal

As shown in FIG. 10, the first shared terminal 3A of the image sharing system 1 activates the web browser according to the input (Step S1). When the input is made so as to connect to the server 4, the first shared terminal 3A performs connection process to the server 4 and judges whether or not the connection is established (Step S2). Such activation of the web browser according to the input by the user may be automated by an automatically run batch program and the like stored in the shared-terminal sub memory 34.

When determining in Step S2 that the connection is not established, the first shared terminal 3A displays (notifies) on the shared-terminal display 32 that failure of the network 2 causes non-connection (Step S3) and terminates the process.

On the other hand, when determined in Step S2 that the connection is established, the first shared terminal 3A downloads the shared-terminal image sharing software 411 from the server 4 (Step S4). The shared-terminal image sharing software 411 is run without being installed according to the input by the user (Step S5).

Subsequently, in order to register the first shared terminal 3A as the shared terminal 3 capable of sharing the image, the first shared terminal 3A transmits the first shared-terminal information 341A to the server 4 (Step S6) and judges whether the image sharing connection request has been received from the personal terminal 5 (Step 7).

When determining in Step S7 that the image sharing connection request is received, the first shared terminal 3A starts the image sharing process with the personal terminal 5 not through the server 4 (Step S8). When determining in Step S7 that the image sharing connection request is not received, the first shared terminal 3A judges whether or not an input to continue waiting for the reception of the image sharing connection request is made (Step S9). Alternatively, the first shared terminal 3A judges whether or not an input to continue waiting for the reception of the image sharing connection request is made when the image sharing process started in Step S8 is aborted by abort of the shared-terminal image software 411. The shared-terminal image sharing software 411 is aborted, for instance, when the user aborts the image sharing process through the personal terminal 5, the power of the personal terminal 5 is turned OFF, or another image sharing connection request is received from another personal terminal 5. A transition condition (not shown) from Step S8 to Step S9 is the abort of the started image sharing process. The abort of the image sharing process is considered to be caused by the abort of the shared-terminal image software 411, for instance, when the user aborts the image sharing process through the personal terminal 5, the power of the personal terminal 5 is turned OFF, or another image sharing connection request is received from another personal terminal 5.

Then, when determining to continue waiting for receiving the image sharing connection request in Step S9, the process of Step S7 is repeated.

On the other hand, when determining to discontinue waiting for receiving the image sharing connection request in Step S9, abort of the image sharing waiting process (cancellation of the registration) is notified to the server 4 (Step S10), whereby the registration as the shared terminal 3 capable of performing the image sharing process registered in the server 4 is cancelled to terminate the process.

Operation of Personal Terminal

As shown in FIG. 11, the personal terminal 5 of the image sharing system 1 activates the web browser according to the input (Step S21) to perform the connection process to the server 4 and judges whether or not the connection is established (Step S22). When determining in Step S22 that the connection is not established, the personal terminal 5 displays (notifies) on the personal-terminal display 52 that failure of the network 2 causes non-connection (Step S23) and terminates the process.

On the other hand, when determining in Step S22 that the connection is established, the personal terminal 5 receives from the server 4 the destination selection request image for identifying the shared terminal 3 capable of performing the image sharing process for display (Step S24). Subsequently, the personal terminal 5 recognizes destination selection for selecting a predetermined shared terminal 3 as a destination (Step S25) and transmits selection result information to the server 4 (Step S26).

The personal terminal 5 receives a download image corresponding to the selection result information from the server 4 for display (Step S27) and judges based on the download image whether or not an input to download the personal-terminal image sharing software 412 has been made (Step S28).

When determining not to download the personal-terminal image sharing software 412 in Step S28, the personal terminal 5 terminates the process. On the other hand, when determining to download the personal-terminal image sharing software 412 in Step S28, the personal terminal 5 requests for such a download to the server 4 and downloads the personal-terminal image sharing software 412 and the shared-terminal information 341 (destination shared-terminal information) of the shared terminal 3 as a destination (Step S29). Subsequently, the personal terminal 5 runs the personal-terminal image sharing software 412 without installation thereof according to the input by the user (Step S30). As shown in FIG. 12, the personal terminal 5 judges whether or not the input to start the image sharing process is made (Step S31).

When determining in Step S31 that the image sharing process is not started, the personal terminal 5 judges whether to terminate the image sharing process based on, for instance, whether the image sharing process is terminated by the user or whether power of the shared terminal 3 as a destination is turned OFF (Step S32). When determining in Step S32 that the image sharing process is terminated, the personal terminal 5 terminates the image sharing process. When determining in Step S32 that the image sharing process is not terminated, the personal terminal 5 repeats the process of S31.

When determining to start the image sharing process in Step S31, the personal terminal 5 establishes the connection with the shared terminal 3 as a destination identified by the shared-terminal information 341 (Step S33) and starts the image sharing process for sharing the image not through the server 4 (Step S34).

Subsequently, the personal terminal 5 judges whether or not to temporarily terminate the image sharing process based on whether or not the image sharing process is aborted by the user, whether or not the request to abort the image sharing process is made by the power OFF of the shared terminal 3 as a destination, or whether or not the request to abort the image sharing process is made by the start of the image sharing process between the shared terminal 3 as a destination and another personal terminal 5 (Step S35). When determining to abort the image sharing process, the personal terminal 5 aborts the image sharing process and repeats the process of Step S31. On the other hand, when determining not to abort the image sharing process in Step S35, the personal terminal 5 repeats the process of Step S35, for instance, after a predetermined elapsed time.

Advantages of Image Sharing System

According to the first exemplary embodiment as described above, the following advantages can be obtained.

(1) The personal terminal 5 of the image sharing system 1 transmits the distribution request information to the server 4 each time the start of the image sharing process is recognized and downloads the shared-terminal information 341 of the shared terminal 3 as a destination which is capable of performing the image sharing process and the personal-terminal image sharing software 412 from the server 4. Then, personal terminal 5 runs the personal-terminal image sharing software 412 to perform the image sharing process with the shared terminal 3 as a destination corresponding to the shared-terminal information 341, not through the server 4.

Thus, no server 4 is required for transmitting and receiving the image. Accordingly, even when the number of the shared terminal 3 as a destination for sharing the image increases, load applied on the server 4 is not increased, so that it is not necessary for the server 4 to have a higher performance. Moreover, since the personal terminal 5 transmits the distribution request information and subsequently downloads the personal-terminal image sharing software 412 at each image sharing process, a cause can be easily specified in case a problem occurs. Specifically, when connection is not established after the distribution request information is transmitted, such non-connection is attributed to the network 2. When connection is not established after the personal-terminal image sharing software 412 is downloaded, such non-connection is attributed to the download process, the personal-terminal image sharing software 412 or a configuration thereof. Accordingly, the image sharing system 1 capable of appropriately dealing with connection failure without increasing costs can be provided.

(2) The personal terminal 5 runs the personal-terminal image sharing software 412 without installation thereof.

Generally, installation requires authorization by an administrator and the like of the terminal (a computer). An unauthorized user (hereinafter, referred to as a general user) is prohibited from installation. For this reason, when the terminal is configured such that the installation of the personal-terminal image sharing software 412 is a prerequisite, the general user cannot use the terminal to access the image sharing system 1.

In contrast, according to this exemplary embodiment, the personal-terminal image sharing software 412 is run without being installed, so that the general user can also access the image sharing system 1.

Further, since the shared-terminal image sharing software 411 is also run without being installed in the shared terminal 3, the same advantages can be obtained.

(3) Among the shared terminals 3 registered in the image sharing system 1, the server 4 can recognize the shared terminal 3 that is capable of performing the image sharing process while running the shared-terminal image sharing software 411, and distributes the shared-terminal information 341 of the shared terminal 3 to the personal terminal 5.

Accordingly, the shared terminal 3 capable of performing the image sharing process in the personal terminal 5 can be reliably selected.

(4) The personal terminal 5 displays the destination selection request image obtained from the server 4 thereon and allows the user to select the shared terminal 3 as a destination. Then, the personal terminal 5 transmits the selection result information to the server 4 according to the input by the user and receives the shared-terminal information 341 of the shared terminal 3 as a destination from the server 4 to perform the image sharing process.

Accordingly, when there are a plurality of shared terminals 3 capable of performing the image sharing process, the image sharing process can be performed between the personal terminal 5 and a shared terminal 3 desired by the user among the plurality of shared terminals 3.

(5) Whether to download the personal-terminal image sharing software 412 in the personal terminal 5 depends on the input by the user.

Accordingly, restriction such as security examination of the personal-terminal image sharing software 412 can be omitted.

### Second Exemplary Embodiment

A second exemplary embodiment of the invention will be described below with reference to the attached drawings.

Arrangement of Image Sharing System

Firstly, an arrangement of an image sharing system will be described.

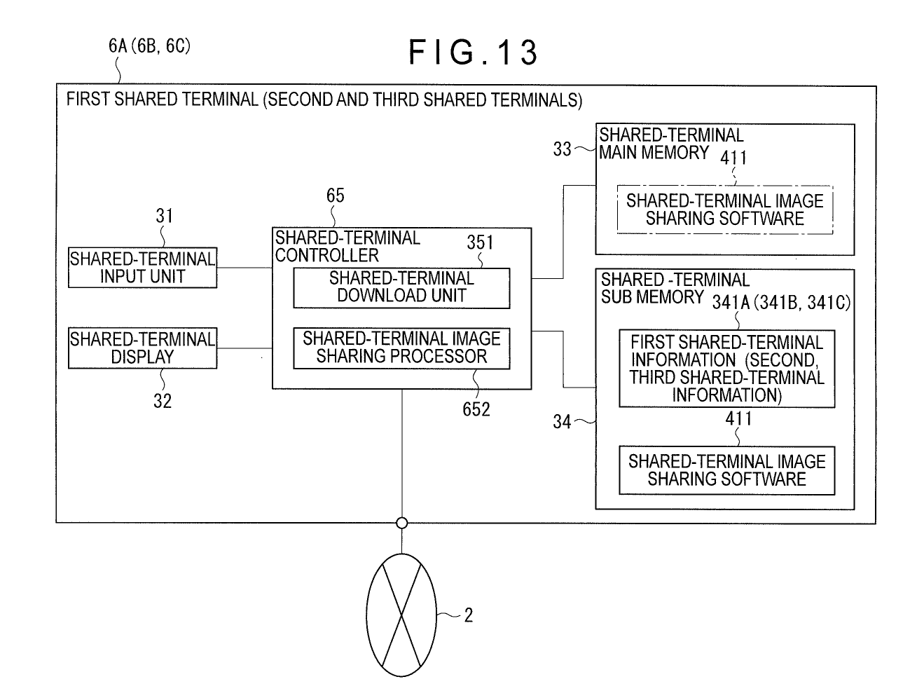

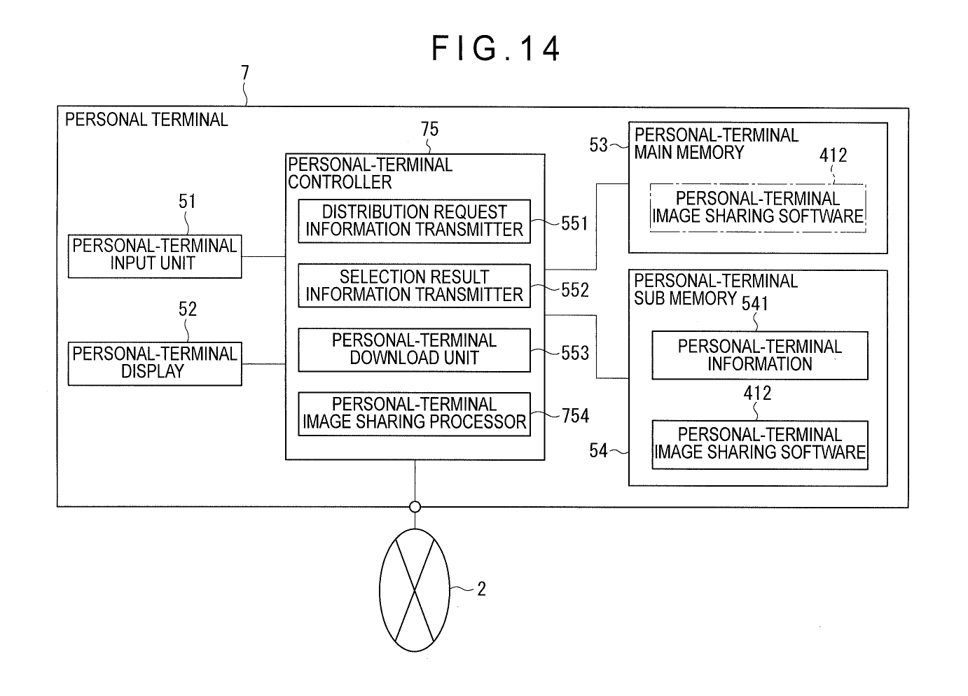

FIG. 13 is a block diagram schematically showing an arrangement of first to third shared terminals. FIG. 14 is a block diagram schematically showing an arrangement of a personal terminal.

As shown in FIG. 1, an image sharing system 1A includes: the network 2; first, second and third shared terminals 6A, 6B and 6C (the first terminal); the server 4; and a personal terminal 7 (the second terminal). Hereinafter, an unspecified one of the first to third shared terminals 6A to 6C is represented by a shared terminal 6 for description.

As shown in FIG. 13, the first to third shared terminals 6A to 6C include the shared-terminal input unit 31, the shared-terminal display 32, the shared-terminal main memory 33, the shared-terminal sub memory 34, and a shared-terminal controller 65.

On the shared-terminal main memory 33 according to the second exemplary embodiment, the shared-terminal image sharing software 411 stored in the shared-terminal sub memory 34 is run.

In the shared-terminal sub memory 34 of the first to third shared terminals 6A to 6C respectively, the first to third shared-terminal information 341A to 341C are stored. In the shared-terminal sub memory 34, the shared-terminal image sharing software 411 is also stored. After the shared-terminal image sharing software 411 is installed, various configurations required for the image sharing process are made to the first to third shared terminals 6A to 6C.

The shared-terminal controller 65 includes the shared-terminal download unit 351 and a shared-terminal image sharing processor 652 (the first image sharing processor), both of which are provided by various programs.

The shared-terminal image sharing processor 652 performs the image sharing process when the shared-terminal image sharing software 411 is installed according to the input by the user and this installed shared-terminal image sharing software 411 is run on the shared-terminal main memory 33. The shared-terminal image sharing processor 652 performs the same process as the shared-terminal image sharing processor 352 according to the first exemplary embodiment.

After the image sharing process, the shared-terminal image sharing processor 652 deletes the shared-terminal image sharing software 411 from the shared-terminal main memory 33, but does not delete the shared-terminal image sharing software 411 from the shared-terminal sub memory 34. Thus, the shared-terminal image sharing processor 652 installs the shared-terminal image sharing software 411 to run. Accordingly, when an image sharing process is repeated after termination of the shared-terminal image sharing software 411, the shared-terminal image sharing processor 652 runs the shared-terminal image sharing software 411 of the shared-terminal sub memory 34 without newly downloading the shared-terminal image sharing software 411 from the server 4.

In such an arrangement without the shared-terminal download unit 351, the shared-terminal image sharing software 411 read from a recording medium such as a CD (Compact Disk), DVD (Digital Versatile Disc) or USB (Universal Serial Bus) memory may be stored in the shared-terminal sub memory 34.

As shown in FIG. 14, the personal terminal 7 includes the personal-terminal input unit 51, the personal-terminal display 52, the personal-terminal main memory 53, the personal-terminal sub memory 54, and a personal-terminal controller 75.

On the personal-terminal main memory 53 according to the second exemplary embodiment, the personal-terminal image sharing software 412 stored in the personal-terminal sub memory 54 is run.

In the personal-terminal sub memory 54, the personal-terminal information 541 and the personal-terminal image sharing software 412 are stored. After the personal-terminal image sharing software 412 is installed, various configurations required for the image sharing process are made to the personal terminal 7.

The personal-terminal controller 75 includes: the distribution request information transmitter 551; the selection result information transmitter 552; the personal-terminal download unit 553; and a personal-terminal image sharing processor 754 (the second image sharing processor), all of which are provided by various programs.

The personal-terminal image sharing processor 754 performs the image sharing process when the personal-terminal image sharing software 412 is installed according to the input by the user and this installed personal-terminal image sharing software 412 is run on the personal-terminal main memory 53. The personal-terminal image sharing processor 754 performs the same process as the personal-terminal image sharing processor 554 according to the first exemplary embodiment.

After the image sharing process, the personal-terminal image sharing processor 754 deletes the personal-terminal image sharing software 412 from the personal-terminal main memory 53 but does not delete the personal-terminal image sharing software 412 from the personal-terminal sub memory 54. Thus, the personal-terminal image sharing processor 754 runs the personal-terminal image sharing software 412 after installation. Accordingly, when image sharing process is repeated after termination of the personal-terminal image sharing software 412, the personal-terminal image sharing processor 754 runs the personal-terminal image sharing software 412 of the personal-terminal sub memory 54 without newly downloading the personal-terminal image sharing software 412 from the server 4.

Operation of Image Sharing System

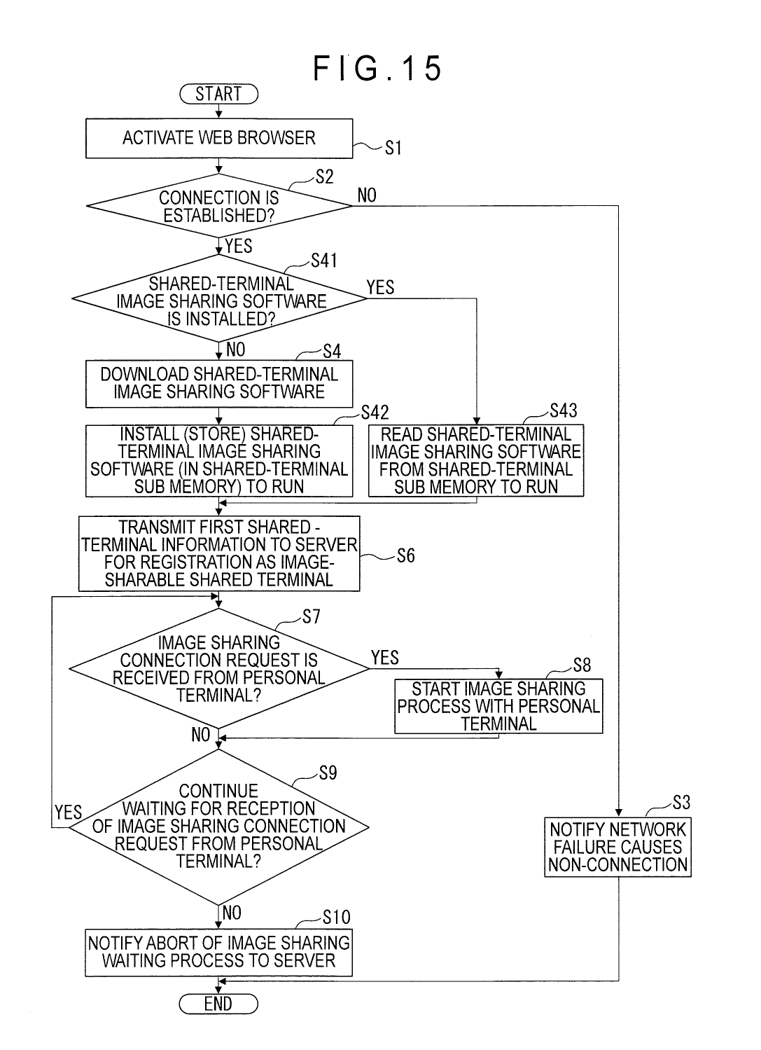

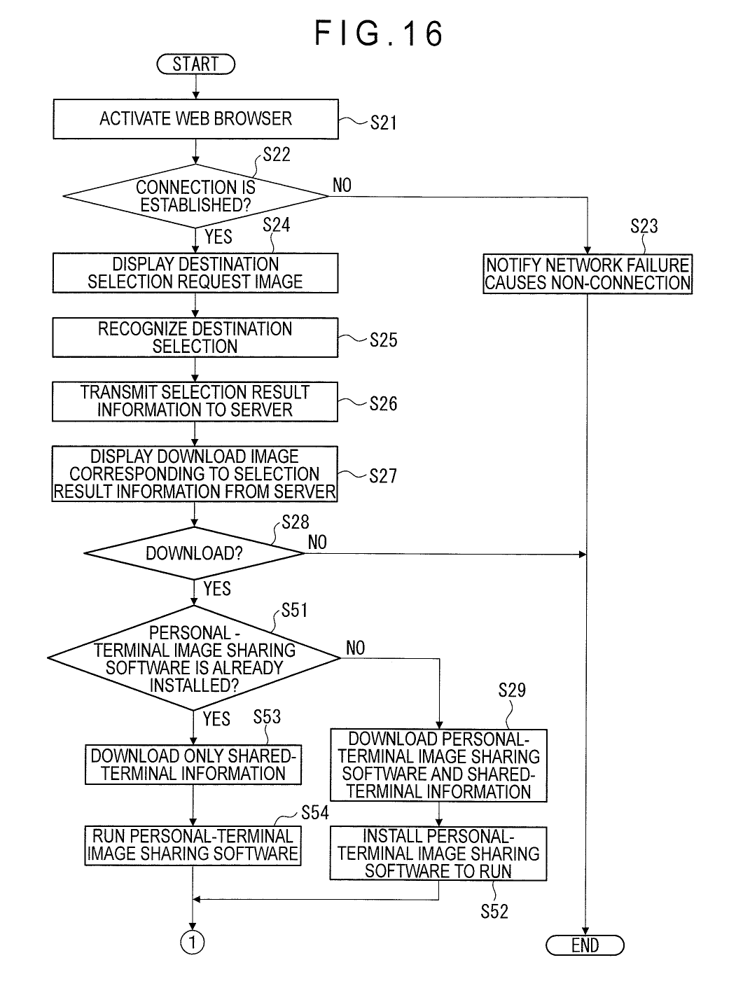

Next, an operation of the image sharing system 1A will be described. FIG. 15 is a flow chart showing an operation of the first shared terminal. The same process as that shown in FIG. 10 (a flow chart showing the operation of the first shared terminal according to the first exemplary embodiment) will be denoted by the same references as those in FIG. 10. FIG. 16 is a flow chart showing an operation of the personal terminal. The same process as that shown in FIGS. 11 and 12 (flow charts showing the operation of the personal terminal according to the first exemplary embodiment) will be denoted by the same references as those in FIGS. 11 and 12.

Operation of Shared Terminal

As shown in FIG. 15, a first shared terminal 6A of the image sharing system 1A performs the process of Steps S1 to S3. When determining in Step S2 that the connection is established, the first shared terminal 6A judges whether or not the shared-terminal image sharing software 411 is installed (Step S41).

When determining in Step S41 that the shared-terminal image sharing software 411 is not installed, the first shared terminal 6A performs the process of Step S4 (i.e., downloads the shared-terminal image sharing software 411 from the server 4) and installs the shared-terminal image sharing software 411 (i.e., stores the shared-terminal image sharing software 411 in the shared-terminal sub memory 34) to run according to the input by the user (Step S42). Subsequently, the processes of Steps S6 to S10 are performed.

On the other hand, when determining in Step S41 that the shared-terminal image sharing software 411 is installed, the first shared terminal 6A reads out the shared-terminal image sharing software 411 from the shared-terminal sub memory 34 to run (Step S43). Subsequently, the processes of Steps S6 to S10 are performed.

Operation of Personal Terminal

As shown in FIG. 16, the personal terminal 7 of the image sharing system 1A performs the processes of Steps S21 to S28. When recognizing based on the download image to download the personal-terminal image sharing software 412 in Step S28, the personal terminal 7 judges whether or not the personal-terminal image sharing software 412 is already installed (Step S51).

When determining in Step S51 that the personal-terminal image sharing software 412 is not installed, the personal terminal 7 performs the process of Step S29 (i.e., downloads the personal-terminal image sharing software 412 and the shared-terminal information 341 from the server 4) and installs the personal-terminal image sharing software 412 (stores the personal-terminal image sharing software 412 in the personal-terminal sub memory 54) to run according to the input by the user (Step S52). Subsequently, the processes of Steps S31 to S35 shown in FIG. 12 are performed.

On the other hand, when determining in Step S51 that the personal-terminal image sharing software 412 is already installed, the personal terminal 7 downloads only the shared-terminal information 341 (Step S53) and reads out the personal-terminal image sharing software 412 from the personal-terminal sub memory 54 to run (Step S54). Subsequently, the process of Steps S31 to S35 is performed.

Advantages of Image Sharing System

In the second exemplary embodiment as described above, the following advantages can be obtained in addition to the advantages (1), (3) to (5) of the first exemplary embodiment.

(6) The personal terminal 7 installs the personal-terminal image sharing software 412 to run.

Accordingly, the personal terminal 7 is not required to download or install the personal-terminal image sharing software 412 at every access to the image sharing system 1A. Consequently, once the personal-terminal image sharing software 412 is downloaded and configuration thereof is made, no more download or configuration thereof is required, so that the time before the start of the image sharing processing can be shortened. Further, since the shared terminal 3 also installs the shared-terminal image sharing software 411 to run, the same advantages can be obtained.

### Third Exemplary Embodiment

A third exemplary embodiment of the invention will be described below with reference to the attached drawings.

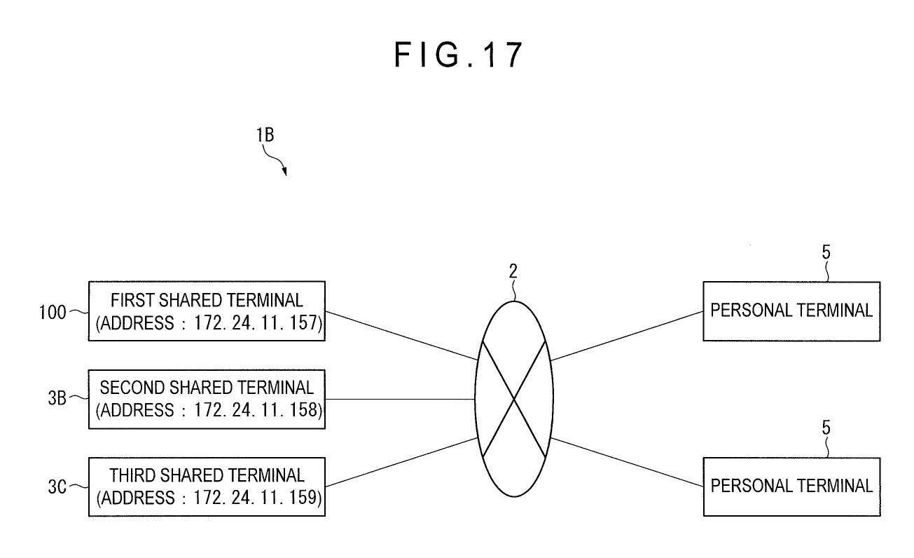

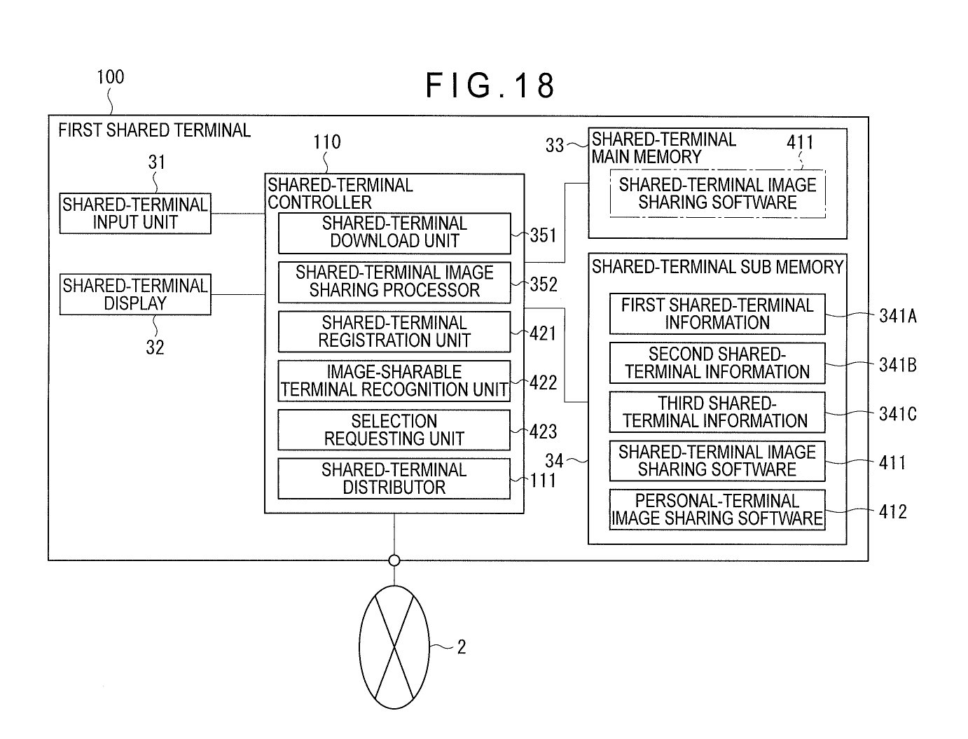

FIG. 17 is a block diagram schematically showing an arrangement of an image sharing system according to the third exemplary embodiment. FIG. 18 is a block diagram schematically showing an arrangement of the first shared terminal.

As shown in FIG. 17, an image sharing system 1B includes: the network 2; the first, second and third shared terminals 100, 3B, and 3C (the first terminal); and two personal terminals 5 (the second terminal).

The first and second shared terminals 3B and 3C are the same as those in the first exemplary embodiment shown in FIG. 2.

The first shared terminal 100, which is a computer, includes the same components as those of the first shared terminal 3A according to the first exemplary embodiment and has the same functions as those of the server 4 according to the first exemplary embodiment. Specifically, as shown in FIG. 18, the first shared terminal 100 includes the shared-terminal input unit 31, the shared-terminal display 32, the shared-terminal main memory 33, the shared-terminal sub memory 34 and a shared-terminal controller 110.

On the shared-terminal main memory 33, the shared-terminal image sharing software 411 is run. In the shared-terminal sub memory 34, the first to third shared-terminal information 341A to 341C, the shared-terminal image sharing software 411 and the personal-terminal image sharing software 412 are stored.

The shared-terminal controller 110 includes the shared-terminal download unit 351, the shared-terminal image sharing processor 352, the shared-terminal registration unit 421, the image-sharable terminal recognition unit 422, the selection requesting unit 423 and a shared-terminal distributor 111 (a first terminal distributor), all of which are provided by various programs.

The shared-terminal distributor 111 performs the same process as that of the server distributor 424 according to the first exemplary embodiment. Specifically, the shared-terminal distributor 111 performs the distribution process to the second and third shared terminals 3B and 3C as shown in FIG. 6 and the distribution process to the personal terminal as shown in FIG. 9.

When performing the image sharing process with the second shared terminal 3B, the personal terminal 5 downloads the personal-terminal image sharing software 412 and the second shared-terminal information 341B from the first shared terminal 100. The personal terminal 5 runs the personal-terminal image sharing software 412 to perform the image sharing process with the second shared terminal 3B not through the first shared terminal 100, in which an image being displayed on the personal terminal 5 is displayed on the second shared terminal 3B. When performing the image sharing process with the first shared terminal 100, the personal terminal 5 downloads the personal-terminal image sharing software 412 and the first shared-terminal information 341A.

Advantages of Image Sharing System

According to the third exemplary embodiment as described above, the following advantages can be obtained.

(7) When the first shared terminal 100 is not selected as the shared terminal 3 as a destination, the image can be transmitted and received not through the first shared terminal 100. Accordingly, even when the number of the shared terminal 3 as a destination for sharing the image is increased, load applied on the first shared terminal 100 is not increased, so that it is not necessary for the first shared terminal 100 to have a high performance. The personal terminal 5 transmits the distribution request information and subsequently downloads the personal-terminal image sharing software 412 at each image sharing process. Accordingly, when a problem of non-connection occurs after the distribution request information is transmitted, or when a problem occurs after the personal-terminal image sharing software 412 is downloaded, a cause of the problem can be easily specified in the same manner as in the first exemplary embodiment. Consequently, the image sharing system capable of appropriately dealing with connection failure without increasing costs can be provided.

### Modifications of Embodiment(s)

Though the invention has been described above with reference to the exemplary embodiments, the scope of the invention is not limited thereto but includes various improvements and variations in the design as long as an object of the invention can be achieved.

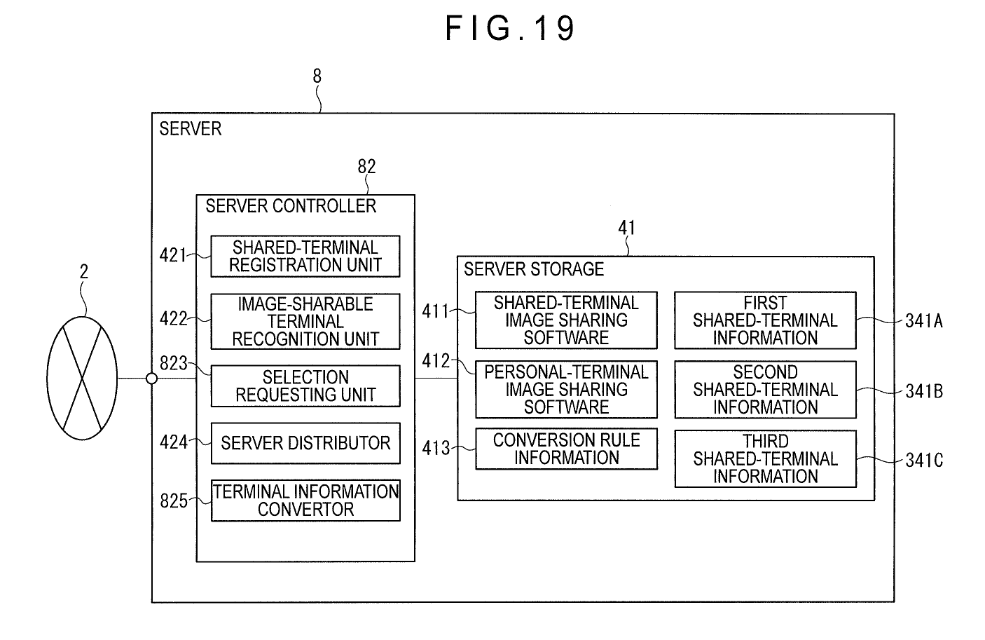

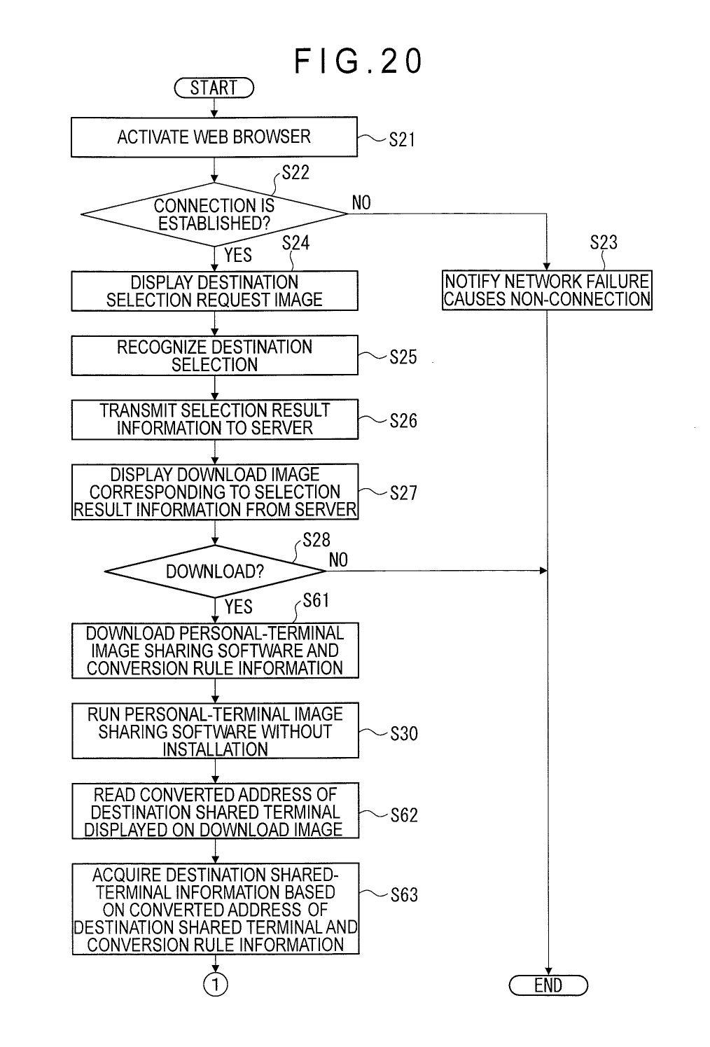

In place of the server 4 according to the first exemplary embodiment, a server 8 as shown in FIG. 19 may be used to perform such process as shown in FIG. 20.

Specifically, the server 8 includes a server controller 82. The server controller 82 further includes a terminal information convertor 825 (an identification information convertor) and a selection requesting unit 823 in place of the selection requesting unit 423 in the server controller 42 of the server 4. Moreover, conversion rule information 413 is also stored in the server storage 41. The conversion rule information 413 records that a numeral representing the IP address of the shared-terminal information 341 is converted to a hexadecimal numeral.

The conversion rule information 413 may record that the numeral of the shared-terminal information 341 is represented by a non-decimal numeral or a letter that is obtained by converting the numeral of the shared-terminal information 341 to a binary numeral, an octal numeral or an alphabet according to a predetermined rule. Further, the conversion rule information 413 may record that the numeral of the shared-terminal information 341 is coded by the hash function and the like. Moreover, the numeral of the shared-terminal information 341 may be converted under different conditions in each of the first to third shared terminals 3A to 3C.

When receiving the selection result information from the personal terminal 5, the terminal information convertor 825 converts the IP address corresponding to the shared terminal 3 as a destination to the hexadecimal IP address according to the conversion rule information 413. For instance, when recognizing that the first shared terminal 3A is selected as the shared terminal 3 as a destination, the terminal information convertor 825 converts “172.24.11.157” of the IP address of the first shared terminal information 341A to “AC180B9D.” The IP address converted to hexadecimal IP address is hereinafter referred to as a converted address for description.

The selection requesting unit 823 transmits a download image to the personal terminal 5, the download image being for displaying the converted address obtained by the terminal information convertor 825 on a title of the browser.

When receiving the selection result information by the process of Step S26 from the personal terminal 5, the server 8 converts the IP address of the shared terminal 3 as a destination to the converted address according to the selection result information. The server 8 creates the download image for displaying the converted address on the title of the browser and distributes the download image to the personal terminal 5.

The personal terminal 5 displays the download image including the converted address in Step S27. When determining download of the personal-terminal image sharing software 412 in Step S28, the personal terminal 5 makes a download request to the server 8.

When receiving the download request, the server 8 distributes the conversion rule information 413 and the personal-terminal image sharing software 412 to the personal terminal 5. At this time, since the personal-terminal image sharing software 412 and the conversion rule information 413 are not changed depending on the shared terminal 3 as a destination, the personal-terminal image sharing software 412 and the conversion rule information 413 are transmitted together.

The personal terminal 5 downloads the personal-terminal image sharing software 412 and the conversion rule information 413 from the server 8 (Step S61) and performs the process of Step S30, i.e., runs the personal-terminal image sharing software 412 without installation thereof.

Subsequently, the personal-terminal image sharing processor 554 of the personal terminal 5 reads the converted address of the shared terminal 3 as a destination (the converted address of a destination shared terminal), the converted address being displayed at a predetermined position on the download image (Step S62). The personal-terminal download unit 553 recovers the decimal address of the destination shared terminal from the converted address according to the conversion rule information 413 and recognizes the destination shared-terminal information before conversion (Step S63). Subsequently, the personal-terminal image sharing processor 554 performs the image sharing process, i.e., the process of Steps S31 to S35 shown in FIG. 12, with the shared terminal 3 as a destination that is identified by the destination shared-terminal information.

With the arrangement shown in FIGS. 19 and 20, the IP address of the shared terminal 3 as a destination that is displayed on the download image in the personal terminal 5 is not a decimal IP address but a converted hexadecimal IP address provided by converting the decimal IP.

Thus, the converted address is displayed on the download image. Accordingly, the shared terminal 3 as a destination is difficult to be identified from the converted address, thereby improving security. Moreover, a download process sequence of the personal-terminal image sharing software 412 and the conversion rule information 413, which are not changed depending on the shared terminal 3 as a destination, and a download process sequence of the converted address, which is changed depending on the shared terminal 3 as a destination, are performed separately, thereby avoiding a complicated process.

The same modification may be applied to the second and third exemplary embodiments.

Alternatively, irrespective of whether or not the shared-terminal image sharing software 411 is running in the shard terminal 3 registered in the image sharing system 1, the shared-terminal information 341 of all the shared terminals 3 may be distributed from the server 4 to the personal terminal 5 to allow the personal terminal 5 to select the shared terminal 3 as a destination.

The first terminal of the invention may be a terminal that is placed on a desk of a specified user or owned by the specified user. The second terminal may be a terminal that is placed, for instance, in a meeting room so as to be usable by an unspecified user. Moreover, the shared terminal 3 may function as the second terminal of the invention, whereby the image displayed on the personal terminal 5 may be displayed on the shared terminal 3 and the image displayed on the shared terminal 3 may be displayed on the personal terminal 5.

The first terminal information of the invention may be one for identifying both the IP address and the port.

Although the destination selection request image is displayed in the personal terminal 5, the same contents as those of the destination selection request image may be notified by a voice to allow the user to select the destination.

Although the shared-terminal image sharing software 411 and the personal-terminal image sharing software 412 are intended as a single-purpose application in the above exemplary embodiments, the shared-terminal image sharing software 411 and the personal-terminal image sharing software 412 may be activated on the web browser.

Further, the image sharing system may include the shared terminal 3 according to the first exemplary embodiment which runs the shared-terminal image sharing software 411 without installation thereof and the personal terminal 7 according to the second exemplary embodiment which runs the personal-terminal image sharing software 412 after installation thereof. Alternatively, the image sharing system may include the shared terminal 6 according to the second exemplary embodiment which runs the shared-terminal image sharing software 411 after installation thereof and the personal terminal 5 according to the first exemplary embodiment which runs the personal-terminal image sharing software 412 without installation thereof.

The above-described components are configured as programs. However, the components may be configured in other configurations, for instance, as hardware such as a circuit board or a single IC (Integrated Circuit). When the components are read from the program or the recording medium, operation can be facilitated and usage can be easily expanded.

A concrete structure and procedure of the exemplary embodiments of the invention may be changed as needed as long as the object of the invention can be achieved.

### Advantages of Exemplary Embodiments

As described above, in the above exemplary embodiments, the personal terminal 5 of the image sharing system 1 transmits the distribution request information to the server 4 each time the start of the image sharing process is recognized and downloads the shared-terminal information 341 and the personal-terminal image sharing software 412 from the server 4. Then, the personal terminal 5 runs the personal-terminal image sharing software 412 without installation thereof to perform the image sharing processing with the shared terminal 3 as a destination corresponding to the shared-terminal information 341, not through the server 4.

Thus, no server 4 is required for transmitting and receiving the image. Accordingly, even when the number of the shared terminal 3 as a destination for sharing the image is increased, load applied on the server 4 is not increased, so that it is not necessary for the server 4 to have a high performance. Moreover, since the personal terminal 5 transmits the distribution request information and subsequently downloads the personal-terminal image sharing software 412 at each image sharing processing, a cause can be easily specified in case a problem occurs. Specifically, when connection is not established after the distribution request information is transmitted, such non-connection is attributed to the network 2 or a network connection configuration of the personal terminal 5. When connection is not established after the personal-terminal image sharing software 412 is downloaded, such non-connection is attributed to a download process, the personal-terminal image sharing software 412 or a configuration thereof. Accordingly, the image sharing system 1 capable of taking an appropriate countermeasure even at connection failure without increasing costs can be provided.

### INDUSTRIAL APPLICABILITY

The invention is applicable as an image sharing system, a server, an image sharing method, an image sharing controlling method, and a recording medium recorded with the image sharing controlling method.

### EXPLANATION OF CODES

1, 1A, 1B image sharing system

2 network

3A, 3B, 3C, 6A, 6B, 6C, 100 first, second and third shared terminals as a first terminal

4, 8 server

5, 7 personal terminal as a second terminal

32 shared-terminal display as a first terminal display

34 shared-terminal sub memory also functioning as a first terminal memory

41 server storage

51 personal-terminal input unit as a terminal input unit

52 personal-terminal display as the second terminal display and a notifier

341A, 341B, 341C first, second and third shared-terminal information as first terminal information

111 shared-terminal distributor as a first terminal distributor

352, 652 shared-terminal image sharing processor as a first image sharing processor

411 shared-terminal image sharing software as a first image sharing software

412 personal-terminal image sharing software as a second image sharing software

413 conversion rule information

422 image-sharable terminal recognition unit

423, 823 selection requesting unit

424 server distributor

551 distribution request information transmitter

552 selection request information transmitter

553 personal-terminal download unit as a data acquirer

554, 754 personal-terminal image sharing processor as a second image sharing processor

825 terminal information convertor as an identification information convertor

1. An image sharing system comprising:
a first terminal provided with a first terminal display capable of displaying a predetermined image;
a second terminal provided with a second terminal display capable of displaying a predetermined image, the second terminal being connectable to the first terminal via a network; and
a server connectable to the first and second terminals via the network,
the image sharing system performing an image sharing process in which the image displayed on the second terminal is simultaneously displayed on the first terminal, wherein
the server comprises:
a server storage in which first terminal information for identifying the first terminal and a second image sharing software for performing the image sharing process at the second terminal are stored; and
a server distributor that distributes the first terminal information and the second image sharing software to the second terminal in response to distribution request information transmitted from the second terminal,
the first terminal comprises a first image sharing processor that acquires a first image sharing software for performing the image sharing process and performs the image sharing process with the second terminal according to the first image sharing software, and
the second terminal comprises:
a distribution request information transmitter that transmits the distribution request information to the server each time a start of the image sharing process is recognized;
a data acquirer that acquires the first terminal information and the second image sharing software in response to the distribution request information; and
a second image sharing processor that runs the second image sharing software after the data acquirer acquires the second image sharing software and that performs the image sharing process with the first terminal identified by the first terminal information, not through the server, wherein
for acquiring the first image sharing software, the first terminal activates a web browser for connection with the server, judges whether or not the connection with the server is established, and displays on the first terminal display that a failure of the network causes non-connection with the server when determining that the connection with the server is not established or acquires the first image sharing software from the server when determining that the connection with the server is established, and
for acquiring the second image sharing software, the second terminal activates a web browser for connection with the server, judges whether or not the connection with the server is established, and displays on the second terminal display that a failure of the network causes non-connection with the server when determining that the connection with the server is not established or acquires the second image sharing software from the server when determining that the connection with the server is established.

2. The image sharing system according to claim 1, wherein
the first terminal includes a plurality of first terminals of which first terminal information is stored in the server storage, the server further comprises an image-sharable terminal recognition unit that recognizes among the plurality of first terminals the first terminal having the first image sharing software running and being capable of performing the image sharing process with the second terminal, and
the server distributor distributes, to the second terminal in response to the distribution request information, the first terminal information of the first terminal recognized by the image-sharable terminal recognition unit to be capable of performing the image sharing process.

3. The image sharing system according to claim 2, wherein
the server further comprises a selection requesting unit that transmits selection request information to the second terminal, the selection request information indicating a request to select at least one of the plurality of first terminals that are recognized to be capable of performing the image sharing process by the image-sharable terminal recognition unit,
the second terminal further comprises:
a terminal input unit capable of inputting various information;
a notifier that notifies the request in response to the selection request information; and
a selection result information transmitter that transmits selection result information of the selected at least one of the first terminals to the server according to the input by the terminal input unit, and
the server distributor distributes the first terminal information of the selected at least one of the first terminals to the second terminal based on the selection result information.

4. The image sharing system according to claim 1, wherein
conversion rule information about a rule for converting the first terminal information to different contents is stored in the server storage,
the server comprises a terminal information convertor that converts the first terminal information based on the conversion rule information,
the server distributor distributes the first terminal information of the first terminal converted by the terminal information convertor and the conversion rule information to the second terminal,
the second terminal further comprises a terminal input unit capable of inputting various information, and
the second image sharing processor performs converted information display process for displaying the converted first terminal information.

5. An image sharing system comprising:
a first terminal provided with a first terminal display capable of displaying a predetermined image; and
a second terminal provided with a second terminal display capable of displaying a predetermined image, the second terminal being connectable to the first terminal via a network,
the image sharing system performing an image sharing process in which the image displayed on the second terminal is simultaneously displayed on the first terminal, wherein
the first terminal comprises:
a first terminal storage in which a second image sharing software for performing the image sharing process at the second terminal is stored;
a first terminal distributor that distributes the second image sharing software to the second terminal in response to distribution request information transmitted from the second terminal; and
a first image sharing processor that acquires a first image sharing software for performing the image sharing process and performs the image sharing process with the second terminal according to the first image sharing software, and
the second terminal comprises:
a distribution request information transmitter that transmits the distribution request information to the first terminal each time a start of the image sharing process is recognized;
a data acquirer that acquires the second image sharing software in response to the distribution request information; and
a second image sharing processor that runs the second image sharing software after the data acquirer acquires the second image sharing software to perform the image sharing process with the first terminal, wherein
for acquiring the second image sharing software, the second terminal activates a web browser for connection with the first terminal, judges whether or not the connection with the first terminal is established, and displays on the second terminal display that a failure of the network causes non-connection with the first terminal when determining that the connection with the first terminal is not established or acquires the second image sharing software from the first terminal when determining that the connection with the first terminal is established.

6. The image sharing system according to claim 1, wherein
the second image sharing processor runs the second image sharing software without installation thereof to perform the image sharing process.

7. A server that controls an image sharing process, the server being connectable via a network with: at least one first terminal provided with a first terminal display capable of displaying a predetermined image; and a second terminal provided with a second terminal display capable of displaying a predetermined image, the second terminal being connectable to the first terminal via the network, the image sharing process allowing an image displayed on the second terminal to be simultaneously displayed on the first terminal, the server comprising:
a server storage in which a first terminal information for identifying the first terminal and a second image sharing software for performing the image sharing process at the second terminal are stored;
an image-sharable terminal recognition unit that recognizes the first terminal among a plurality of the first terminals, the first terminal having a first image sharing software running and being capable of performing the image sharing process with the second terminal, the first terminal information of the plurality of the first terminals being stored in the server storage; and
a server distributor that distributes the first terminal information of the first terminal being recognized by the image-sharable terminal recognition unit to be capable of performing the image sharing process and the second image sharing software to the second terminal in response to the distribution request information, and that runs the second image sharing software on the second terminal in response to the distribution to perform the image sharing process between the second terminal and the first terminal identified by the first terminal information not through the server.

8. The server according to claim 7, wherein
the server storage stores conversion rule information about a rule for converting the first terminal information to different contents,
the server comprises a terminal information convertor that converts the first terminal information based on the conversion rule information, and
the server distributor distributes the first terminal information of the first terminal converted by the terminal information convertor and the conversion rule information to the second terminal, and displays the first terminal information before conversion according to the conversion rule information on the second terminal.

9. An image sharing method of performing an image sharing process using: a first terminal provided with a first terminal display capable of displaying a predetermined image; a second terminal provided with a second terminal display capable of displaying a predetermined image, the second terminal being connectable to the first terminal via a network; and a server connectable to the first and second terminals via the network, the image sharing process allowing the image displayed on the second terminal to be simultaneously displayed on the first terminal, the server comprising a server storage that stores first terminal information for identifying the first terminal and a second image sharing software for performing the image sharing process at the second terminal, the method comprising:
for acquiring the first image sharing software for performing the image sharing process in the first terminal, judging whether or not the connection with the server is established by activating a web browser by the first terminal for connection with the server, and displaying on the first terminal display that a failure of the network causes non-connection with the server when determining that the connection with the server is not established or acquiring the first image sharing software from the server when determining that the connection with the server is established;
each time a start of the image sharing process is recognized at the second terminal, judging whether or not the connection with the server is established by activating a web browser by the second terminal for connection with the server, and displaying on the second terminal display that a failure of the network causes non-connection with the server when determining that the connection with the server is not established or transmitting distribution request information from the second terminal to the server when determining that the connection with the server is established;
distributing the first terminal information and the second image sharing software from the server to the second terminal in response to the distribution request information; and
when the second image sharing software is acquired on the second terminal, running the second image sharing software on the second terminal to perform the image sharing process between the second terminal and the first terminal that is identified by the first terminal information and is capable of performing the image sharing process according to the first image sharing software, not through the server.

10. An image sharing method of performing an image sharing process using: a first terminal provided with a first terminal display capable of displaying a predetermined image; and a second terminal provided with a second terminal display capable of displaying a predetermined image, the second terminal being connectable to the first terminal via a network, the image sharing process allowing the image displayed on the second terminal to be simultaneously displayed on the first terminal, the first terminal comprising a first terminal storage in which a second image sharing software for performing the image sharing process at the second terminal is stored; the method comprising:
each time a start of the image sharing process is recognized at the second terminal, judging whether or not the connection with the first terminal is established by activating a web browser by the second terminal for connection with the first terminal, and displaying on the second terminal display that a failure of the network causes non-connection with the first terminal when determining that the connection with the first terminal is not established or transmitting distribution request information from the second terminal to the first terminal when determining that the connection with the first terminal is established;
distributing the second image sharing software from the first terminal to the second terminal in response to the distribution request information; and
when the second image sharing software is acquired on the second terminal, running the second image sharing software on the second terminal to perform the image sharing process between the second terminal and the first terminal that is capable of performing the image sharing process according to a first image sharing software.

11. An image sharing controlling program that causes a computer to function as the server according to claim 7.

12. A recoding medium recorded with an image sharing controlling program in which the image sharing controlling program according to claim 11 is recorded in a computer-readable manner.

13. The image sharing system according to claim 5, wherein
the second image sharing processor runs the second image sharing software without installation thereof to perform the image sharing process.
